(19) United States
(12) Patent Application Publication
(10) Pub. No.: US 2018/0263245 A1
(43) Pub. Date: Sep. 20, 2018

(54) WATER-BASED DISINFECTANT

(71) Applicants: Christian CREMONA, Beirut (LB); Nabil HABIB, Beirut (LB)

(72) Inventor: Nabil HABIB, Beirut (LB)

(21) Appl. No.: 15/550,907

(22) PCT Filed: Feb. 5, 2016
(86) PCT No.: PCT/IB2016/050599

§ 371 Date: Apr. 27, 2018

(30) Foreign Application Priority Data
Feb. 12, 2015 (LB) 10564

(51) Int. Cl. A01N 59/20

(52) U.S. Cl. CPC A01N 59/20; A01N 33/12

(57) ABSTRACT

Anti micro-organism water-based detergent to disinfect Clinical, Institutional, Domestic and Industrial Contaminations This preparation is intended to be used for clinical, institutional, domestic and industrial environments as well as protection of crops such as vines, coffee, tea, tobacco, peanuts, potatoes and other fruits, vegetables, grains, cereals, as well as wood, furniture and any kind of food (whether of animal origin or vegetable origin), institutional, domestic, clinical (including laboratory and medical) surface and equipment, and industrial (including laboratory and pharmaceutical) areas. Moreover, this preparation is also suitable for solid, liquid and gaseous wastes. It is Bactericidal, Mycobactericidal, Turbeculocidal, Fungicidal, Yeasticidal, Sporicidal and Virucidal The field of application is also against Biofilm activity, fungus, molds, virus, bacteria, algae, yeasts, moss, spores, worms and other Micro-Organisms.

### TECHNICAL FIELD

Anti micro-organism water-based detergent to disinfect Clinical, Institutional,

Domestic and Industrial Contaminations, with activity against biofilm

### BACKGROUND ART

Disrupting micro-organism membranes.

The structural functionality of the Cu π-Complex in Quaternary Ammonium Chloride, especially the role of chain polarity on activity against different bacteria, has been previously observed. π-Complex with Quaternary Ammonium Chloride with a C12 hydrophobic tail length affected the outer membrane of gram-negative bacteria more extensively than shorter-chain compounds, possibly due to the C12 chain interacting strongly with the fatty acid portion of lipid A. It was also reported that π-Complex with Quaternary Ammonium Chloride bind by ionic and hydrophobic interactions to microbial membrane surfaces, with the cationic head group facing outwards and the hydrophobic tails inserted into the lipid bi-layer, causing the rearrangement of the membrane and the subsequent leakage of intracellular constituents

### SUMMARY OF INVENTION

This invention relates to a water-based anti micro-organism detergent consisting of Copper π-Complex with Quaternary Ammonium Cations.

The developed formula is: Dodecyl Dimethyl Benzyl Ammonium/Copper π-Complex

### Technical Problem

Microbial contaminations are today's problems in several fields of human life, and one of the biggest challenges facing health, environment, nutrition and general wellbeing.

A post-treatment of a contamination be it to a human being, to an animal, to food products, to a crop, or to any other product, being a costly and less efficient approach than pre-treatment and removal of contaminations, the problem arises on how to remove contaminations in a safe, fast and efficient way.

The disinfectant required needs to be broad in action, covering most of today's known microbial contaminations, with a high log reduction at the shortest possible time, and at the same time having a low toxicity to humans, and being easy and safe to handle: Non-toxic, non-corrosive, non-flammable, non-hazardous.

The activity coverage of the disinfectant needs to include Biofilms, which are slimy aggregates of microbes that are likely responsible for many chronic infections as well as for contamination of clinical, institutional, domestic and industrial environments. It also needs to be active against a broad spectrum of bacteria (gram-negative and gram-positive), viruses, fungi, spores, and other micro-organisms.

### Solution to Problem

Copper π-Complex of Dodecyl Dimethyl Benzyl Ammonium Chloride, a Water-Based disinfectant (hereinafter “ezoMED”), to be used for clinical, institutional, domestic and industrial environments as well as protection of crops such as vines, coffee, tea, tobacco, peanuts, potatoes and other fruits, vegetables, grains, cereals, as well as wood, furniture and any kind of food (whether of animal origin or vegetable origin), institutional, domestic, clinical (including laboratory and medical) surface and equipment, and industrial (including laboratory and pharmaceutical) areas.

Moreover, this preparation is also suitable for solid, liquid and gaseous wastes.

It is Bactericidal, Mycobactericidal, Turberculocidal, Fungicidal, Yeasticidal, Sporicidal and Virucidal

The field of application is also against Biofilm activity, fungus, molds, virus, bacteria, algae, yeasts, moss, spores, worms and other Micro-Organisms.

The greatest activity is associated with the π-Complex Benzyl and C12 derivatives. The mechanism of bactericidal/microbicidal action is thought to be due to disruption of intermolecular interactions. This can cause dissociation of cellular membrane lipid bilayers, which compromises cellular permeability controls and induces leakage of cellular contents. Other biomolecular complexes within the bacterial cell can also undergo dissociation. Enzymes, which finely control a wide range of respiratory and metabolic cellular activities, are particularly susceptible to deactivation. Critical intermolecular interactions and tertiary structures in such highly specific biochemical systems can be readily disrupted by cationic surfactants.

π-Complex DDBAC solutions are rapidly acting biocidal agents with a moderately long duration of action. They are active against bacteria and viruses, fungi, and protozoa. Bacterial spores are considered to be resistant. Solutions are bacteriostatic or bactericidal according to their concentration.

Although hazardous levels are not likely to be reached under normal use conditions, it has been proved that this surfactant can pose a hazard to marine organisms. The π-Complex DDBAC is effective at very low ppm levels, so excess use should be avoided.

PLEASE NOTE: This product is exclusively for EXTERNAL use only and not suitable for human or animal consumption.

### Advantageous Effects of Invention

The 12-chain Quaternary Ammonium being one of the Best in the family of Quaternary Ammonium Chlorides, which is a very well known Disinfectant. We have 2×C₁₂ chains in our molecule

The π-Complex, which increases dramatically the killing power over bacteria, viruses, fungi and other micro-organisms, while reducing the toxicity (vs. humans) of the product at the same time

The additional power of Cu (Copper) in the π-Complex. Copper being a natural antimicrobial element

Being a Water-Based disinfectant

Having a 2-in-1 activity: Cleaning+Disinfection/Sterilization

One product to kill all micro-organisms

Fast action within seconds+reach sterilization levels. High Log killing for microorganism.

Non-toxic, non-flammable

Non-aggressive to metals (does not contain aldehydes), non-corrosive, non-tainting

Neutral pH (soft on hands)

Highly active even with large dilution rates

### BRIEF DESCRIPTION OF DRAWINGS

FIG. 1 represents our developed formula

FIG. 2 is a report we got from Haroun Hospital showing successful results obtained ESBL with 30 seconds contact time

FIG. 3 shows ESBL incubated on untreated media

FIG. 4 shows media treated by 50% diluted ezoMED disinfectant+1 colony of ESBL, remaining Sterile after 24 hours incubation

FIG. 5 shows media treated by 50% diluted ezoMED disinfectant+2 colonies of ESBL, remaining Sterile after 24 hours incubation

FIG. 6 shows media treated by 50% diluted ezoMED disinfectant+3 colonies of ESBL, remaining Sterile after 24 hours incubation

FIG. 7 shows an in-house test performed at our laboratory showing an untreated sample, infected with Pseudomonas aeruginosa after 24 hours incubation

FIG. 8 shows an in-house test performed at our laboratory showing an untreated sample, infected with Pseudomonas aeruginosa after 48 hours incubation

FIG. 9 shows an in-house test performed at our laboratory showing 72 hours incubation of a treated sample, originally infected with Pseudomonas aeruginosa, disinfected with 100 ppm of ezoMED Water-Based Disinfectant, showing a sterile incubation

FIG. 10 shows a sample from the output of an infected Water Plant, before Treatment, incubated for 72 hours

FIG. 11 shows a sample from the output of the same infected Water Plant as per [FIG. 10

FIG. 12 shows a sample from output of the same infected Water Plant as per [FIG. 10

FIG. 13 shows test Results performed in the Industrial Research Institute, demonstrating bactericidal efficacy against Pseudomonas aeruginosa, with a contact time of 1 minute. Test was conducted in the spirit of the European pharmacopoeia

FIG. 14 shows test Results performed in the Industrial Research Institute, demonstrating bactericidal efficacy against Staphylococcus aureus, with a contact time of 1 minute. Test was conducted in the spirit of the European pharmacopoeia

FIG. 15 illustrates our reduced developed formula

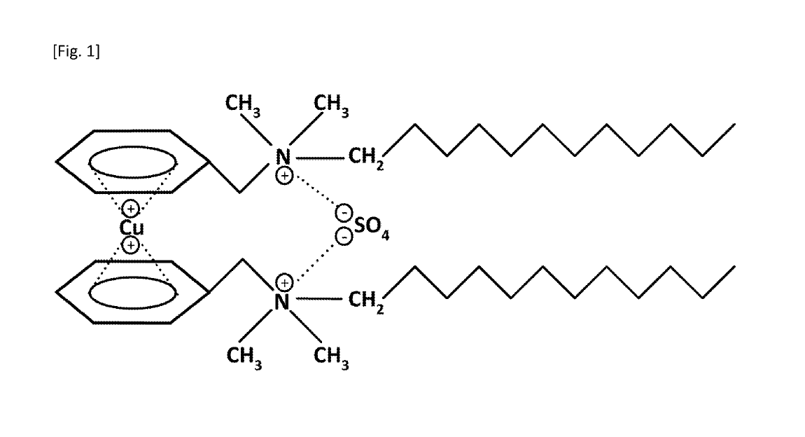

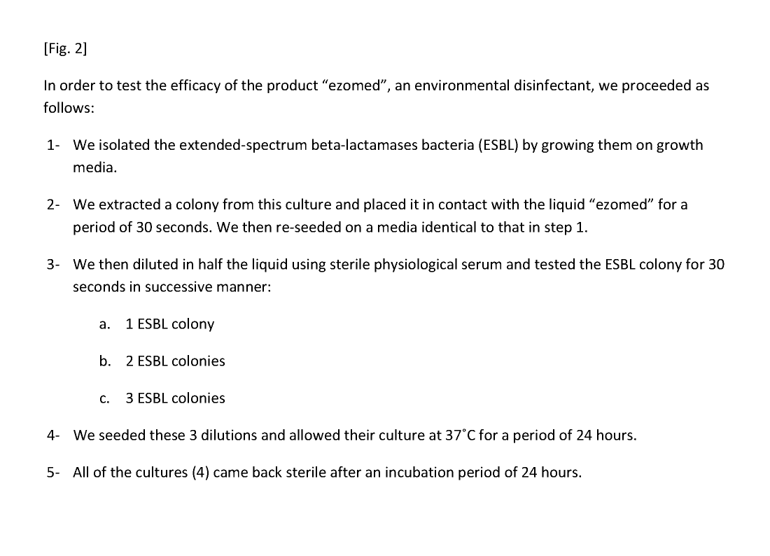

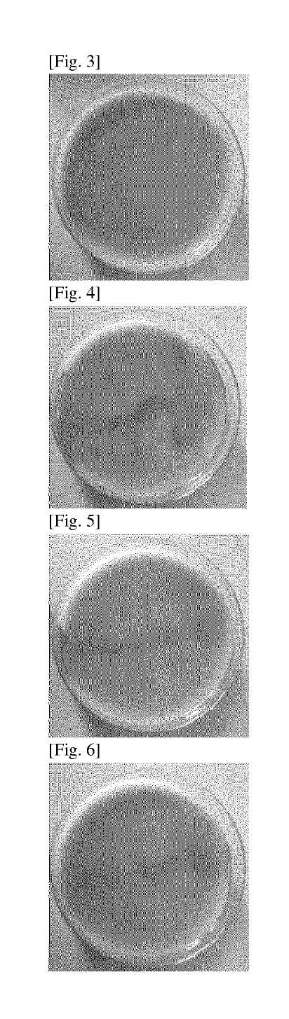

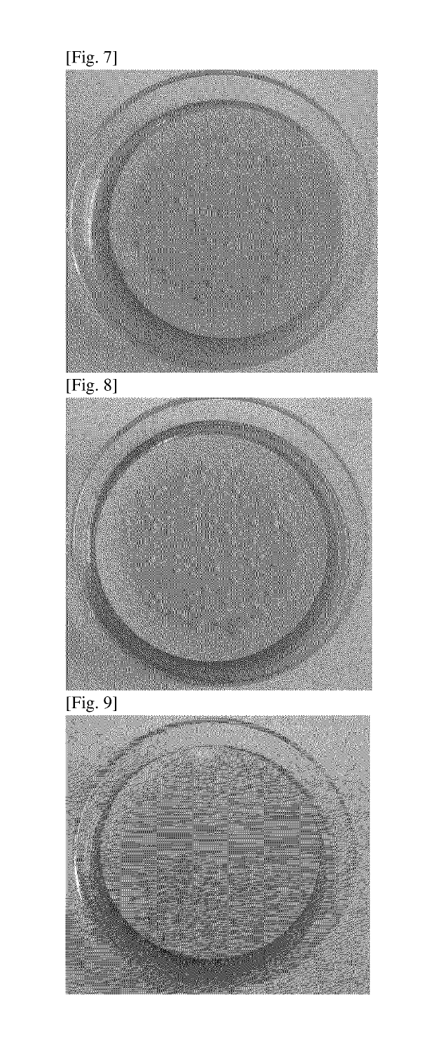

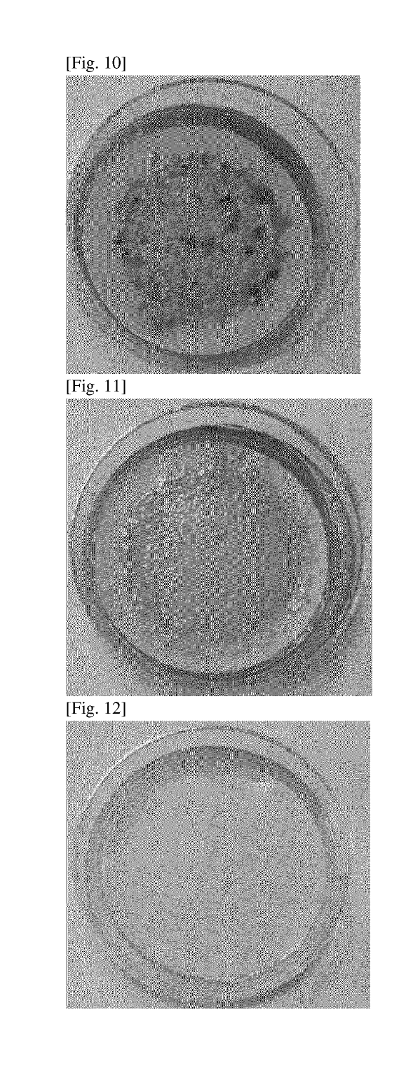

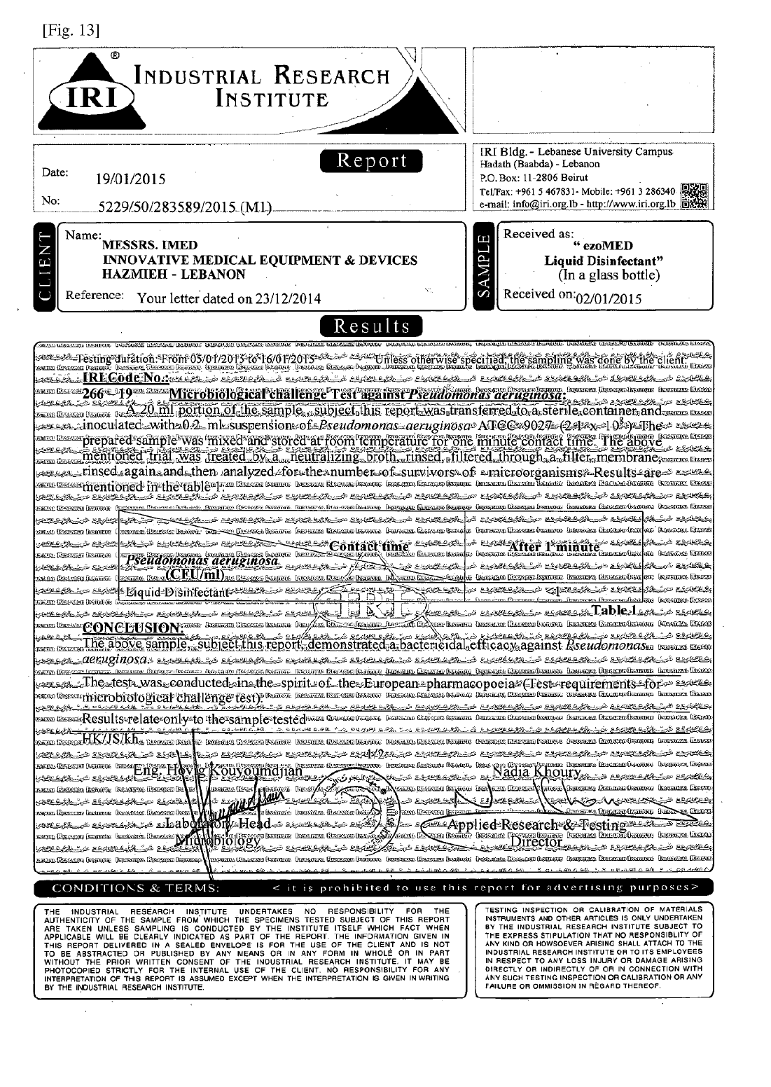

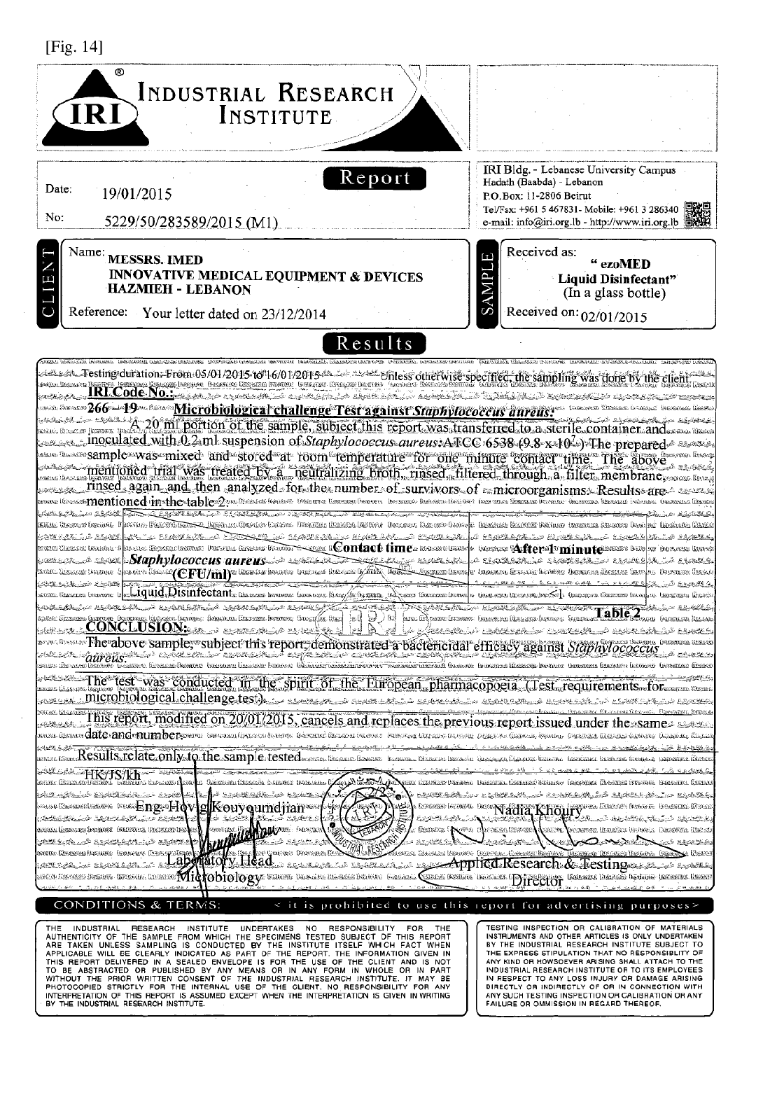

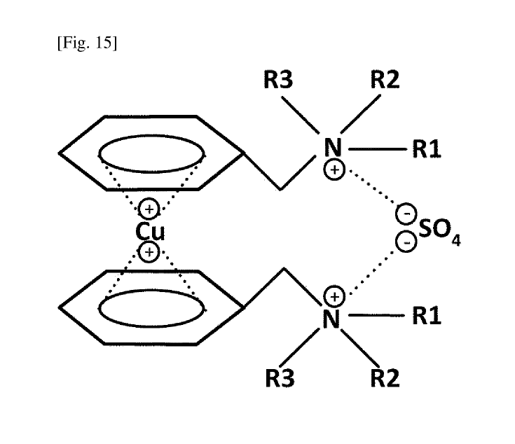

### DESCRIPTION OF EMBODIMENTS

This preparation is intended to be used for clinical, institutional, domestic and industrial environments as well as protection of crops such as vines, coffee, tea, tobacco, peanuts, potatoes and other fruits, vegetables, grains, cereals, as well as wood, furniture and any kind of food (whether of animal origin or vegetable origin), institutional, domestic, clinical (including laboratory and medical) surface and equipment, and industrial (including laboratory and pharmaceutical) areas.

Moreover, this preparation is also suitable for solid, liquid and gaseous wastes.

It is Bactericidal, Mycobactericidal, Turbeculocidal, Fungicidal, Yeasticidal, Sporicidal and Virucidal

The field of application is also against Biofilm activity, fungus, molds, virus, bacteria, algae, yeasts, moss, spores, worms and other Micro-Organisms.

Biofilms are slimy aggregates of microbes that are likely responsible for many chronic infections as well as for contamination of clinical, institutional, domestic and industrial environments. Pseudomonas aeruginosa is a prevalent hospital pathogen that is well known for its ability to form Biofilms that are recalcitrant to many different antimicrobial treatments. This approach was used to look for changes in Biofilm susceptibility to various biocides when these agents were combined with metal ions.

This process identified that Copper π-Complex with Quaternary Ammonium compounds and especially the Dodecyl Dimethyl Benzyl Ammonium Sulfate works synergistically in this field to kill Pseudomonas aeruginosa Biofilms and the above mentioned pathogens.

Our results prove that this π-Complex works against a broad spectrum of microbial activity and eradicates Biofilms of Escherichia coli, Staphylococcus aureus, Salmonella, enterica serovar Choleraesuis, and Pseudomonas fluorescens. To investigate the mechanism of action, isothermal titration calorimetry was used to show that the π-Complex does not interact in aqueous solutions, suggesting that it exerts microbiological toxicity through independent biochemical routes. Additionally the π-Complex Quaternary Ammonium alone reduces the activity of nitrate reductases, which are enzymes that are important for normal Biofilm growth, and it is effective against combinations of microbes and bacterial Biofilms.

Biofilms are cell-cell or solid surface-attached assemblages of microbes that are entrenched in a hydrated, self-produced matrix of extracellular polymers. There is increasing recognition among life and environmental scientists that Biofilms are a prominent form of microbial life that may cause many different problems, ranging from biofouling and corrosion to plant and animal diseases. As a result, there are now numerous studies describing Biofilm susceptibility to single-agent antimicrobial treatments, yet despite this explosion of information, there are relatively few studies that have systematically examined Biofilm susceptibility to combinations of antimicrobials. This gap in our knowledge is an important matter to investigate.

Recent findings suggest that the decreased susceptibility of Biofilms is linked to a process of phenotypic diversification that is ongoing within the adherent population. This means that there are likely multiple cell types in single-species Biofilms that ensure population survival in the face of any single adversity. Treating Biofilms with combinations of chemically distinct antimicrobials might be an effective strategy to kill some of these different cell types. In light of this emerging perspective, our research group undertook the present study to explore the possibility of using combinations of rationally selected agents, as described below, to treat Biofilms of the opportunistic pathogen Pseudomonas aeruginosa. This micro-organism is well studied and suited for Biofilm research, as P. aeruginosa Biofilms are much more resilient to conventional forms of chemical removal and disinfection than their corresponding populations of planktonic cells.

Which antimicrobial agents may be used to treat Biofilms of P. aeruginosa? Lately, several inorganic metal species have attracted attention as antibacterials because they exert time-dependent toxicities that kill Biofilms in vitro as well as Pseudomonas aeruginosa in vivo. It is important that microbicidal concentrations of certain toxic metal species may be poisonous to higher organisms, and therefore, this hazard limits the choices and concentrations of inorganic ions that may be used as part of antimicrobial treatments. However, certain metal ions with relatively lower biological toxicities to humans and to the environment might still be useful in many products—including disinfectants, surface coatings, hard surface treatments, and topical ointments—particularly in combination with detergents or other cleansers. The specific aim of this study, therefore, was to identify metal ions that might synergistically enhance the efficacy of biocides against Pseudomonas aeruginosa Biofilms.

We developed a high-throughput technique for Biofilm susceptibility testing and examined antimicrobial activity of π-Complex Dodecyl Dimethyl Benzyl Ammonium Chloride arrays representing several combinations of metals and biocides and included variations in concentrations of individual agents as well as different exposure times.

We found out that the Copper π-Complex combination of metal and biocide conforms exactly to our aim. By evaluating these combinatorial panels for bactericidal and antibiofilm activity, we identified and subsequently rigorously validated that Copper enhanced the in vitro killing of P. aeruginosa biofilms by quaternary ammonium compounds (QACs).

### EXAMPLES

Tests performed on Pseudomonas aeruginosa and Staphylococcus aureus infected surfaces showed complete sterilization within few seconds.

Tests performed on infected water tubing in a Water Plant showed much faster and better results than conventional disinfection with destruction of biofilm

Bacteria that produce enzymes called extended-spectrum beta-lactamases (ESBLs), which are highly resistant to disinfectants, have been completely removed by disinfecting with our product, within few seconds of application.

Concentrations as low as 100 ppm were still very active as a sterilizing agent against Pseudomonas aeruginosa and Staphylococcus aureus, again within few seconds of application

Live tests on Swimming Pools have showed a successful alternative to Conventional Disinfection

Immersion of dental tools in a 1,000 ppm solution of our product after a chirurgical intervention in a dental clinic achieved complete removal of soil, protein residues and body fluids in addition to sterilization of the infected tools, which showed a dual activity of cleaning and disinfecting. Time of action was less than 5 minutes

### Industrial Applicability

Applicability #1:

Water-soluble preparation as a broad spectrum disinfectant suitable for sterilization of:

Hospitals, clinics:
Spaces and environments, including walls and floors and hard surfaces including Terminal Disinfection of Hospital Rooms, Operating Rooms, Intensive Care Units, Transplant Units (BMT units), Emergency Rooms and other High Risk Rooms and Services; Medical and Clinical Tools and Equipment including Surgical devices,
Medical devices, endoscopes, arthroscopes, haemodialysers; non-invasive Medical Equipment, transducers and probes, Medical Imaging Equipment disinfection (MRI, X-Ray, . . . ), Ultrasound and Patient Monitoring Equipment;
Furniture and Constructions including but not limited to patient beds and tables and furniture handles, as well as nurse-call devices and OR lights and handles;
Food;
Solid, Liquid and gaseous wastes and residues;

Applicability #2:

Water-soluble preparation as a broad spectrum disinfectant suitable for sterilization of:

Clean Rooms, Ultra-Clean Rooms and Isolation Rooms (Negative Pressure and/or Positive Pressure) in Hospitals and Ultra-Clean Industries like Semi-conductors, Space Industry and Fine Chemicals as well as Aseptic, Sterile rooms and other critical manufacturing environments:
Spaces and environments, including walls and floors and hard surfaces;
Medical, Clinical and Manufacturing Tools and Equipment including Sterilizing equipment;
Furniture and Constructions including exterior surfaces of air ducts, air vents and pipes;
Solid, Liquid and gaseous wastes and residues;

Applicability #3:

Water-soluble preparation as a broad spectrum disinfectant suitable for sterilization of:

HealthCare Facilities such as Assisted Living or Full Care Nursing Homes, Physical Therapy Rooms or Areas, Patient Areas, Physicians' Offices, Psychiatric Facilities, Home Health Care Settings, Public Areas, Hospices Radiology or X-Ray Rooms or Areas, CAT Laboratories, Recovery Rooms, Retirement Homes, Rehabilitation Centers, Respiratory Centers, Respiratory Therapy Rooms or Areas, Laundry Rooms Restrooms, Long Term Care Facilities, Medical Facilities, Medical Offices, Medical Clinics, Dialysis Facilities, Nursing Homes, Waiting Areas, Nurses' Stations, Donation Centers, Examination Rooms, Ophthalmic Offices, Out-Patient Surgical Centers and Facilities:
Spaces and environments, including walls and floors and hard surfaces;
HealthCare Tools and Equipment including wheelchairs, emergency carts, examination tables;
Furniture and Constructions;
Food;
Solid and Liquid wastes and residues;

Applicability #4:

Water-soluble preparation as a broad spectrum disinfectant suitable for sterilization of:

Ambulances, Ambulatory Care Centers Ambulatory Surgical Centers:
Spaces and environments, including walls and floors and hard surfaces;
Ambulatory and Surgical Tools and Equipment including carts and door handles;
Furniture and Constructions;
Solid and Liquid wastes and residues;

Applicability #5:

Water-soluble preparation as a broad spectrum disinfectant suitable for sterilization of:

Dentist clinics:
Spaces and environments, including walls and floors and hard surfaces;
Surgical and Dentistry Tools and Equipment;
Furniture and Constructions including patient dental chairs;
Solid and Liquid wastes and residues;

Applicability #6:

Water-soluble preparation as a broad spectrum disinfectant suitable for sterilization of:

Laboratories:
Spaces and environments, including walls and floors and hard surfaces;
Laboratory Tools and Equipment including incubators, Laminar Flow Cabinets, Sterilizers, Hoods and Autoclaves;
Furniture, Benchtops and Constructions including sinks, and benchtop fixtures;
Contaminated Glass and Plastic Labware;
Solid, Liquid and gaseous wastes and residues;

Applicability #7:

Water-soluble preparation as a broad spectrum disinfectant suitable for sterilization of:

Pharmaceutical, Biotechnological and Medical device Industries:
Spaces and environments, including walls and floors and hard surfaces;
Tools and Equipment;
Furniture and Constructions;
Solid, Liquid and gaseous wastes and residues;

Applicability #8:

Water-soluble preparation as a broad spectrum disinfectant suitable for sterilization of:

Institutional areas (Pharmaceutical, Cosmetics and Food Industries):
Spaces and environments, including walls and floors and hard surfaces;
Tools and Equipment including Industrial Filling machines, Mixers, . . . ;
Furniture and Constructions including worktables and benchtop fixtures;
Yeasts, Proteins, Enzymes, etc . . . ;
Used as fungicidal product to kill fungus, mold and algae
Solid, Liquid and gaseous wastes and residues;

Applicability #9:

Water-soluble preparation as a broad spectrum disinfectant suitable for sterilization of:

Institutional areas (Beauty Centers):
Spaces and environments, including walls and floors and hard surfaces;
Tools and Equipment including cosmetics and toiletries;
Furniture and Constructions including worktables and chairs;
Solid, Liquid and gaseous wastes and residues;

Applicability #10:

Water-soluble preparation as a broad spectrum disinfectant suitable for sterilization of:

Institutional areas (Hotels, Restaurants, Pubs, Malls and Catering Establishments):
Spaces and environments, including walls and floors and hard surfaces;
Tools and Equipment including tabletops, kitchens utensils, heaters, cosmetics and toiletries
Toilets and waste containers;
Furniture and Constructions including worktables and benchtop fixtures;
Solid, Liquid and gaseous wastes and residues;

Applicability #11:

Water-soluble preparation as a broad spectrum disinfectant suitable for sterilization of:

Institutional areas (Public Areas, Schools, Nurseries, Universities, Public Buildings, Shops, Offices, Public Transport and Workplaces in general):
Spaces and environments, including walls and floors and hard surfaces;
Tools and Equipment;
Furniture and Constructions;
Toilets and waste containers;
Solid, Liquid and gaseous wastes and residues;

Applicability #12:

Water-soluble preparation as a broad spectrum disinfectant suitable for sterilization of:

Institutional areas (Municipal facilities like Slaughterhouses, Waste Recycling, Triage areas):
Spaces and environments, including walls and floors and hard surfaces;
Tools and Equipment;
Furniture and Constructions;
Toilets and waste containers;
Solid, Liquid and gaseous wastes and residues;

Applicability #13:

Water-soluble preparation as a broad spectrum disinfectant suitable for sterilization of:

Food of animal origin:
milk and milk products;
meat and meat products;
fish, seafood, and related products;
eggs and egg products;
animal feeds;
etc. . . .

Applicability #14:

Water-soluble preparation as a broad spectrum disinfectant suitable for sterilization of:

Food of vegetable origin:
beverages;
fruits, vegetables and derivatives (including sugar, distillery, etc.);
flour, milling and baking;
animal feeds;
etc. . . .

Applicability #15:

Water-soluble preparation as a broad spectrum disinfectant suitable for sterilization of:

Water Bottling and Beverage Industries:
Spaces and environments, including walls and floors and hard surfaces;
Tools and Equipment including Filling Units, pipes, mixers, . . . ;
Furniture and Constructions;
Solid, Liquid and gaseous wastes and residues;

Applicability #16:

Water-soluble preparation as a broad spectrum disinfectant suitable for sterilization of:

Water Treatment and Water Plants:
Spaces and environments, including walls and floors and hard surfaces;
Tools and Equipment including pipes (interior and exterior);
Furniture and Constructions;
Used as fungicidal product to kill fungus, mold and algae
Solid, Liquid and gaseous wastes and residues;

Applicability #17:

Water-soluble preparation as a broad spectrum disinfectant suitable for sterilization of:

Animal Farming, Veterinary Care and Animal Waste:
Spaces and environments, including walls and floors and hard surfaces;
Tools and Equipment;
Furniture and Constructions;
Animal Food;
Solid, Liquid and gaseous wastes and residues;

Applicability #18:

Water-soluble preparation as a broad spectrum disinfectant suitable for sterilization of:

Health Clubs, Sporting Clubs, Swimming Pools and Sports Rooms:
Spaces and environments, including walls and floors and hard surfaces; as well as bathrooms, shower stalls, locker rooms and other clean hard surfaces commonly contacted by bare feet;
Tools and Equipment including water-circulating pipes;
Furniture and Constructions;
Used as fungicidal product to kill fungus, mold and algae
Solid, Liquid and gaseous wastes and residues;

Applicability #19:

Water-soluble preparation as a broad spectrum disinfectant suitable as an Algaecide for clearing of algae, moss and lichens from paths, roof tiles, swimming pools, masonry and horticultural greenhouse disinfection

Applicability #20:

Water-soluble preparation as a broad spectrum disinfectant suitable for sterilization of:

Warehouses, Stocking, Preservation and Production areas:
Spaces and environments, including walls and floors and hard surfaces;
Tools and Equipment including Ultra-Low Freezers, Freezers, Refrigerators,

Freeze-Dryers, Storage Cabinets, . . . );
Furniture and Constructions;
Packaging Materials
Solid, Liquid and gaseous wastes and residues;

Applicability #21:

Water-soluble preparation as a broad spectrum disinfectant suitable as a Multi-Surface mould, algae and moss remover. Surfaces like: Stainless Steel, Chrome, Formica, glass, painted surfaces, vinyl, plastics (Polycarbonate, PVC, Polypropylene, Polystyrene), Plexiglas, Porcelain, Epoxy, Resin Solid Surface, . . . .

Applicability #22:

Water-soluble preparation as a broad spectrum disinfectant suitable for sterilization of:

Oilfield Sector:
Spaces and environments, including walls and floors and hard surfaces;
Microbial Corrosion inhibitor;

Applicability #23:

Water-soluble preparation as a broad spectrum disinfectant suitable for sterilization of:

Domestic areas:
Spaces and environments, including walls and floors and hard surfaces; as well as kitchen tops, sinks, tabletops, kitchen and cooking utensils, bathrooms, shower stalls, locker rooms and other clean hard surfaces commonly contacted by bare feet
Tools and Equipment including computer and communication accessories and peripherals as well as cosmetics and toiletries;
Furniture and Constructions;
Food;
Solid, Liquid and gaseous wastes and residues;

Applicability #24:

Water-soluble preparation to remove bad smells and stinking odors resulting from the action of disinfecting and killing micro-organism and bacteria responsible for such.

It also has cleaning and disinfecting activities in one operation and thus acts as a broad spectrum disinfectant and a daily cleaning detergent, although it could be mixed with any other antiseptic agent or any other detergent having its pH between 6 and 8 to perform the same purposes stated above.

### PATENT LITERATURE

PTL 1: Chemical Name: Dodecyl Dimethyl Benzyl Ammonium/Copper π-Complex
PTL 2: Code Name: DDAC/Cu/5
PTL 3: Technical grade: DDAC/Cu/5 is an aqueous solution of π-Complex Copper in Dodecyl Dimethyl Benzyl Ammonium, Sandwich structure
PTL 4: Typical properties

Appearance at 25° C.: Clear Blue Liquid

Color: Blue

Density at 20° C.: 1.0 g/cm 3

Active matter: 5.0%

Free Amine: 0.10% max.

pH (5% sol): 7.5±0.5

Composition: 5% active solution in water
PTL 5: Dodecyl Dimethyl Benzyl Ammonium Chloride, also known as DDBAC, is a nitrogenous cationic surface active agent belonging to the quaternary ammonium chloride. It has two main categories of use; as a biocide and a cationic surfactant
PTL 6: π-Complex DDBAC is readily soluble in ethanol, IPA and acetone. Although dissolution in water is slow, aqueous solutions are easier to handle and are preferred. Solutions should be neutral to slightly alkaline, with color ranging from light Blue to Blue. Solutions foam profusely when shaken.
PTL 7: ezoMED is a π-complex of C12 Quaternary Ammonium Chloride (Dodecyl Dimethyl Benzyl Ammonium Chloride) with ion Copper, so it benefits from both worlds (Quaternary Ammonium Disinfectant+copper-based antimicrobial) with more synergy and biocidal activity but with less toxicity.

### NON PATENT LITERATURE

NPL 1: Even without the Cu π-complex activity, the C12 Quaternary Ammonium Chloride is FDA approved as Safe and Effective as an active for antiseptic drug products (1),
NPL 2: and as an active ingredient for oral rinse/mouthwash (2).
NPL 3: It exceeded the FDA-indicated minimum performance standards for bacterial reduction (3).
NPL 4: It is also FDA approved for eye and nasal drops, leave-on skin antiseptics, hygienic towelettes and wet wipes (4)
NPL 5: and FDA recognized as one of the best hand sanitizers (5).
NPL 6: It is FDA Food Safety approved for 0.25 to 1 ppm (δ)
NPL 7: even allowed as a food preservative (7)
NPL 8: and benefits from the US EPA food tolerance exemption (8)
NPL 9: and is EPA approved to be used as a sanitizer on counter tops, utensils, appliances, tables, . . . and as an Algaecide, . . . and that its Toxicity database is complete (9).
NPL 10: It is strongly recommended as a useful Virucidal agent by the NCBI-NLM-NIH USA (10),
NPL 11: whereas Health Canada states it as active against Bacteria, Virus and Fungi . . . to be used in Industrial/Institutional areas (schools, office buildings), Hospitals, Dental Clinics, Nursing Homes, Food Processing and Barns (11).
NPL 12: Furthermore, EPA does not believe it poses unacceptable reproductive risks, does not believe it is a genetic toxicant, and is found to be negative for introduction of tumors (12).
NPL 13: On the other hand Copper is a natural antimicrobial material which, in very small quantities has the power to control a wide range of molds, fungi, algae and harmful microbes, such as Aspergillus, Bacillus, Candida, Poliovirus, and inactivates bacteria and viruses with a broad spectrum effect on flu (H1N1, H5N1 avian strain, 2009 H1N1 swine flu), as per international Journals publications.

(1) for 0.1% 0.13% w/w as per FDA FR56(140)

(2) for up to 0.1% concentrations as per FDA FR58(27)

(3) 21CFR333.470(b)(2)

(4) FDA FR56(140)

(5) FDA docket No. 75N-183H

(6) FDA FR172.165

(7) Up to 0.004% as per FDA FR172.165

(8) Up to 400 ppm of active Quaternary compound as per EPA-HQ-OPP-2008-0533 40CFR180.940

(9) 40CFR180.940

(10) PMID:18032831

(11) Minimum in-use concentrations of up to 450 ppm as per the Hard Surface Disinfectants Monograph

(12) 40CFR180.940

1. A Water-Based Disinfectant consisting of the Cu π-Complex of the Quaternary Ammonium according to the developed formula

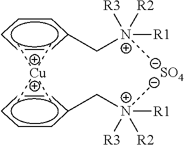

2. The invention of claim 1 will act as an antiseptic against: Bacteria, Mycobacteria, Tuberculosis, Fungi, Yeasts, Spores, Viruses, Biofilm activity, Molds, Algae, Moss, Worms, and other Micro-Organisms. And this is not limitative, but just an example

3. Whatever is R1, R2, R3, in the invention of claim 1 especially Dimethyl Dodecyl, the molecule will perform a similar activity

4. The metallic ion Cu in the invention of claim 1 or any other ion divalent, monovalent or polyvalent, will achieve the same task

5. The ion Sulfate in the invention of claim 1 could be replaced by any other ion, and the molecule will perform a similar task

6. Any mixture of the invention of claim 1 with any other detergent having its pH between 6 and 8 could be used for the same purposes stated above

7. Any mixture of the invention of claim 1 with any other antiseptic agent could be used for the same purposes stated above

8. The invention of claim 1 being a water-soluble preparation as a broad spectrum disinfectant suitable for sterilization of all uses as per section “Industrial Applicability” above, using any other metal in π-Complex Dodecyl Dimethyl Benzyl Ammonium Chloride, and the π-Complex could be achieved with any other metal at any concentration and with all kinds of Antiseptic Agents

9. All the Applicabilities mentioned under the section “Industrial Applicability” constitute our claims also. The listed Applicabilities above constitute a non-limitative list of performance and represent only examples of what has been achieved till date. Any other antiseptic use could be advised after consulting our scientific team

10. The invention of claim 1 has the power to remove bad smells and stinking odors resulting from the action of disinfecting and killing micro-organism and bacteria responsible for such

11. The invention of claim 1 has cleaning and disinfecting activities in one operation and thus acts as a broad spectrum disinfectant with instant reactions, and a daily cleaning detergent suitable for the same purposes stated above

12. The invention of claim 1 will achieve a complete removal of All Micro-organism and Biofilm at any concentration from 50,000 ppm (fifty thousand ppm) down to 100 ppm with practically an instant response (few seconds)

13. The Listed claims above constitute a non-limitative list of claims and represent only examples of what has been performed till date. The Listed claims above constitute a non-limitative list of claims and represent only examples of what has been performed till date. Any other antiseptic use could be advised after consulting our scientific team
